(19) United States
(12) Patent Application Publication
(10) Pub. No.: US 2009/0159645 A1
(43) Pub. Date: Jun. 25, 2009

(54) Brazing alloy compositions and methods

(76) Inventors: Laurent Cretegny, Niskayuna, NY (US); Ann Melinda Ritter, Niskayuna, NY (US); Shyh-Chin Huang, Latham, NY (US); Liang Jiang, Schenectady, NY (US); Warren Martin Andre Miglietti, Greenville, NC (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 12/316,889

(22) Filed: Dec. 16, 2008

Related U.S. Application Data
(60) Provisional application No. 61/016,107, filed on Dec. 21, 2007.

(51) Int. Cl. C22C 19/05; B23K 31/02; C22C 19/07

(52) U.S. Cl. 228/119; 420/442; 420/451; 420/436; 420/438

(57) ABSTRACT

Various braze alloy compositions are described, along with methods for using them. In one instance, a boron-free, high-temperature braze alloy includes selected amounts of chromium, hafnium, and nickel. The braze alloy can be used, for example, as a component in a wide gap braze mixture where a higher or lower melting point superalloy and/or brazing powder is used. The braze alloys may permit joining or repairing of superalloy articles with complex shapes, and may be used in high temperature applications. In some other braze alloy embodiments, a nickel- or cobalt-based braze composition can contain selected amounts of boron, but includes restricted amounts of chromium.

This patent application claims priority from U.S. Provisional Application 61/016,107, filed on Dec. 21, 2007 for Shyh-Chin Huang et al, the entire disclosure of which is incorporated herein by reference.

### BACKGROUND

This invention generally relates to braze alloy compositions. More specifically, the invention relates to nickel-based and cobalt-based braze alloy compositions.

In order to function effectively in a high-temperature environment, heavy alloy components are typically added to strengthen a superalloy. This may result in difficulties for welding joining/repair of superalloy components used in an extreme environment, such as a hot-gas-path airfoil in a gas turbine. Brazing is becoming a more preferred choice for joining/repair of superalloy components as a result of its reduced cost and cycle time. However, it can be challenging to provide the braze joints or repair sections with certain properties—especially ductility—approaching that of the superalloy substrate material. Generally, a primary obstacle can be the formation of brittle phases in the brazed joint.

Boron has been used extensively in brazing alloys, but brittle borides typically result in poor mechanical properties of the braze joint. A process to improve the mechanical integrity of the braze joint/repaired area generally requires the use of a prolonged diffusion cycle. This approach may reduce the amount of brittle boride phases by homogenization with substrate superalloys or a braze powder mixture. This process, however, may require a prolonged cycle time, increasing cost and subjecting the substrate superalloy to thermal degradation. By eliminating boron as an element to suppress the solidus temperature, both the joint properties and the ease of processing may be improved.

Several braze alloy compositions are described in commonly assigned U.S. Pat. No. 7,156,280, wherein a nickel-based braze alloy composition comprises 9-25% chromium by weight, 5-45% hafnium by weight, and 0.05-6% boron by weight, and wherein a cobalt-based braze alloy composition comprises 9-25% chromium by weigh, 10-56% hafnium by weight, and 0.05-6% boron by weight.

It should be apparent that new braze alloy compositions would be welcome in the art. In some preferred embodiments, the alloy compositions should be substantially free of boron, so as to minimize the formation of brittle phases in brazed joints or other components in which the braze material is incorporated. In addition to enhanced ductility, the braze alloy compositions should also exhibit acceptable strength, as well as oxidation- and corrosion-resistance for some end uses. Moreover, the braze compositions should possess melt properties (e.g., solidus/liquidus temperature characteristics) which provide good flexibility for brazing processes which involve materials of varying composition.

### BRIEF DESCRIPTION OF THE INVENTION

Brazing compositions and methods disclosed herein enable elimination of boron while retaining the ability to melt the braze in the required temperature ranges. By using Hf to suppress the melting point in the absence of boron, the braze does not form large brittle phases which decrease ductility.

Briefly, in accordance with one embodiment disclosed herein, a nickel-based braze alloy composition comprises: about 5% to about 15% chromium by weight, about 6% to about 26% hafnium by weight, and balance nickel, wherein the alloy composition is free of boron.

In accordance with another embodiment disclosed herein, a nickel-based braze alloy composition consists essentially of: about 5% to about 15% chromium by weight, about 6% to about 26% hafnium by weight, and about 50% to about 70% nickel by weight.

In accordance with another embodiment disclosed herein, a cobalt-based braze alloy composition comprises: about 5% to about 15% chromium by weight, about 6% to about 26% hafnium by weight, and balance cobalt, wherein the alloy composition is free of boron.

For other embodiments of this invention, the braze alloy composition (nickel- or cobalt-based) can include boron, but contains restricted amounts of chromium. In one specific embodiment, the composition comprises:

about 5% by weight to about 8.5% by weight chromium;

hafnium;

about 0.05% by weight to about 6% by weight boron; and

a balance, comprising nickel, cobalt, or a combination of nickel and cobalt.

### DETAILED DESCRIPTION

A boron-free high-temperature braze alloy composition is disclosed herein. Nickel-based compositions are initially described for purposes of example, but cobalt-based compositions are also included herein. In one embodiment, the composition comprises nickel (Ni), chromium (Cr), and hafnium (Hf). In other embodiments, the braze alloy composition can further comprise at least one element selected from the group consisting of cobalt (Co), tungsten (W), titanium (Ti), and aluminum (Al). The braze alloy can be used as a single homogenous braze or as a component in a wide gap braze mixture where higher or lower melting point superalloys and/or brazing powders are used. The boron-free braze alloys may permit joining or repairing of superalloy articles with complex shapes (with one example being crack repair), and may be used in high temperature applications.

In embodiments disclosed herein, Hf is used to suppress the solidus temperature, and Cr and Hf are coupled to suppress the liquidus temperature. Additionally, the Cr may be used to provide oxidation and corrosion resistance to the brazing alloys. A chromium-, and hafnium-containing intermetallic compound may be more ductile than chromium-, tungsten-, and nickel-containing borides, which are commonly found in brazes which rely on boron to suppress the solidus temperature. With the elimination of boron, there are fewer brittle intermetallic phases which are known to decrease braze and joint ductility and toughness. Thus, brazing may be accomplished at high temperatures without degrading a superalloy substrate, and borides that are otherwise formed during brazing processes may be eliminated. It is expected that these embodiments may be useful to improve mechanical properties of braze alloys, especially ductility.

In one embodiment, a nickel-based braze alloy composition comprises: about 5% to about 15% chromium by weight, about 6% to about 26% hafnium by weight, and balance nickel, wherein the alloy composition is free of boron.

In a more specific embodiment, the nickel-based braze alloy composition consists essentially of: about 5% to about 15% chromium by weight, about 6% to about 26% hafnium by weight, and about 50% to about 70% nickel by weight, wherein the alloy composition is free of boron.

In another embodiment, a nickel-based braze alloy composition consists essentially of: about 5% to about 15% chromium by weight, about 6% to about 26% hafnium by weight, about 50% to about 70% nickel by weight, and about 1% to about 7% aluminum by weight.

In still another embodiment for certain end use applications, the nickel-based braze alloy composition consists essentially of chromium, hafnium, nickel, and aluminum, as set forth above, and also contains at least one element selected from the group consisting of cobalt, tungsten, and titanium. Exemplary, non-limiting ranges for these elements are as follows: up to about 12% cobalt by weight (e.g., about 1% to 12% cobalt), about 3% to about 7% tungsten by weight, and up to about 2.5% titanium by weight (e.g., about 1% to about 2.5% titanium). The relative amounts of these elements are to some degree dependent on the workpiece being brazed. In other words, the braze alloy composition is often formulated to be compatible with the composition of the superalloy of the workpiece. The desired liquidus temperature for the braze is also a factor.

In accordance with other specific embodiments which are sometimes of interest, chromium is present at about 7% by weight to about 9% by weight; hafnium is present at about 14% by weight to about 26% by weight; cobalt is optional, or is present at up to about 7% by weight; tungsten is present at about 4% by weight to about 5.6% by weight; titanium is present about 1% by weight to about 2% by weight; and/or aluminum is present at about 2% by weight to about 4.5% by weight. The level of nickel in the braze alloy is usually at about 50% by weight to about 65% by weight.

In some (but not all) embodiments, the braze composition may contain other elements as well. The selection of the particular elements exemplified below will depend in part on the various factors noted above, such as requirements for strength, ductility, and oxidation resistance. Economic considerations (e.g., the cost of braze constituents), as well as material availability, are also considerations. Other elements (sometimes referred to herein as “secondary elements”) which are sometimes included in the braze composition include tantalum, rhenium, iron, niobium, molybdenum, manganese, carbon, silicon, and zirconium. The factors described previously provide guidance as to the inclusion of these elements, and their relative amounts. Usually, each element of the group of tantalum, rhenium, iron, niobium, and molybdenum is optionally present at a level no greater than about 6 weight percent (e.g., 0.1 weight percent to about 6 weight percent). Moreover, each element of the group of manganese, carbon, silicon, and zirconium is optionally present at a level no greater than about 0.5 weight percent (e.g., 0.1 weight percent to about 0.5 weight percent) Impurities and other minor elements (i.e., in addition to these elements) may sometimes be present, but are typically kept at less than about 0.2% (by weight) of the total braze composition.

In one embodiment, the nickel-based braze alloy composition has a solidus temperature less than about 2175° F. (1191° C.). In a more specific embodiment, the nickel-based braze alloy composition has a solidus temperature less than about 2100° F. (1149° C.). In some instances, the nickel-based alloy composition preferably has a solidus temperature less than about 2025° F. (1107° C.).

Table 1 depicts five, exemplary nickel-based braze alloy compositions.

TABLE 1
Compositions of Boron-Free Hafnium-Containing
Braze Alloys (in weight-percent)

| Ingot | Alloy | Cr | Co | W | Ti | Al | C | Hf | Ni |
|---|---|---|---|---|---|---|---|---|---|
| 9023 | Ni—Hf-2 | 7.4 | | 4.7 | 1.4 | 2.3 | 0.03 | 25.5 | 58.7 |
| 9025 | Ni—Hf-3 | 8.4 | | 5.4 | 1.6 | 6.1 | | 14.5 | 64 |
| 9024 | Ni—Hf-5 | 8.3 | 5.6 | 5.3 | | 4.3 | | 14.2 | 62.4 |
| 9026 | Ni—Hf-7 | 7.9 | 5.4 | 5 | 1.5 | 4.1 | 0.04 | 20.3 | 55.8 |
| 9020 | NiHf-E | 8.5 | | | | | | 25 | 66.5 |

The alloys of Table 1 have considerable breadth in microstructural characteristics, such as type and size of intermetallic phases. Since Hf-containing intermetallic phases can be ductile, the mechanical properties of these brazes may be preferable to those for boron-containing brazes, where the presence of brittle borides can decrease ductility and other mechanical properties. An initial evaluation of impact properties showed that the Ni—Hf-2 (9023), Ni—Hf-7 (9026) and Ni—Hf-E (9020) compositions may be the most ductile, while Ni—Hf-3 (9025) may be less ductile but could have acceptable properties.

Table 2 depicts the solidus and liquidus temperatures for these compositions, and the difference (delta) between the solidus and liquidus temperatures. The temperatures in Table 2 are based on differential scanning calorimetry (DSC) heating curve analysis. The data in this table demonstrate that boron-free, hafnium-containing braze alloys may have beneficial properties.

TABLE 2
DSC Results of Hafnium-Containing Braze Alloys

| Ingot | Alloy | Solidus (° F.) | Liquidus (° F.) | Delta |
|---|---|---|---|---|
| 9023 | Ni—Hf-2 | 2084 | 2340 | 256 |
| 9025 | Ni—Hf-3 | 1920 | 2046 | 126 |
| 9024 | Ni—Hf-5 | 2165 | 2433 | 268 |
| 9026 | Ni—Hf-7 | 1893 | 2210 | 317 |
| 9020 | NiHf-E | 2183 | 2338 | 155 |

The nickel-based braze alloy composition has a solidus temperature in one embodiment of less than about 2175° F. (1191° C.). In a more specific embodiment, the nickel-based braze alloy composition has a solidus temperature less than about 2100° F. (1149° C.). In an even more specific embodiment, the nickel-based alloy composition has a solidus temperature less than about 2025° F. (1107° C.). The difference between the solidus and liquidus temperatures (delta) varies widely across these compositions, and this process flexibility may be of use in brazing substrate alloys of different compositions, applications and property requirements.

Another embodiment of the invention is directed to a method for joining two metal components formed of nickel-based alloys. The method comprises the following steps: a) placing a joint-forming amount of the braze composition described herein between the metal components to be joined; b) heating the braze composition to a brazing temperature sufficient to melt the composition, but not the adjacent components; and c) cooling the braze composition so that it re-solidifies and forms a joint between the components. An optional addition is to include diffusion either by pausing the cooling ramp down at a predetermined temperature, or by having a post-cooling heat treatment.

A related embodiment is directed to a repair method comprising (a) placing an amount of the braze composition described herein within a crack or other type of cavity in a component being repaired; (b) heating the braze composition to a brazing temperature sufficient to melt the composition, but not the component; and (c) cooling the braze composition so that it re-solidifies within the cavity. Again, diffusion may be an optional addition. Additionally, in both embodiments, the braze alloy can be used on its own or as a component in a wide gap braze mixture where a higher or lower melting point superalloy and/or brazing powder is used. The term “crack” is exemplary here. The repair method can be undertaken on many types of holes, cavities, pits, dents, indentations, and other forms of damage.

Other information regarding brazing technology is available from various sources. Examples include U.S. Pat. Nos. 7,156,280 (Jiang et al); 6,520,401 (Miglietti); and U.S. Patent Application 2005/0067061 (Huang et al, Mar. 31, 2005). These disclosures are incorporated herein by reference.

The braze composition can be used in many forms for this process, such as slurry, tape, or foil. The use of the particular braze composition described herein may desirably result in the formation of a strong braze segment which exhibits very good ductility, along with acceptable oxidation- and corrosion-resistance. A typical, important application of this process involves crack repair in gas turbine components.

As used herein “boron-free” and “free of boron” are each meant to include an absence of boron except for any impurity levels of boron that may inadvertently be present in the composition. It is expected that such impurities would be no more than about 0.04 weight percent of the composition.

Still another embodiment of the present invention is directed to a boron-free cobalt, high-temperature braze alloy composition. In one embodiment, the composition comprises cobalt (Co), chromium (Cr), and hafnium (Hf).

In other embodiments, the cobalt-based braze alloy composition can further comprise at least one element selected from the group consisting of nickel (Ni), tungsten (W), titanium (Ti), and aluminum (Al). As in the case of the nickel-based alloys, these cobalt-based compositions can be used as a single homogenous braze, or as a component in a wide gap braze mixture where higher or lower melting point superalloy and/or brazing powder is used. The boron-free braze alloys may permit joining or repairing of superalloy articles with complex shapes, and may be used in high temperature applications.

In some specific embodiments, the cobalt-based braze alloys comprise: about 5% to about 15% chromium by weight, about 6% to about 26% hafnium by weight, and balance cobalt. Typically, the level of cobalt is about 50% to about 70% by weight, based on the weight of the entire alloy composition. The cobalt-based alloy may further comprise: up to about 12% nickel by weight, about 3% to about 7% tungsten by weight, up to about 2.5% titanium by weight; and about 1% to about 7% aluminum by weight. Moreover, in some embodiments, the alloy composition may comprise at least one of the secondary elements described previously.

The cobalt-based braze alloys can also be used to carry out a method for joining two metal components formed of cobalt-based alloys or for component repair, in a manner similar to that described for the nickel-based alloys.

In still another embodiment of this invention, the hafnium-containing braze materials (based on nickel or cobalt) always contain restricted levels of chromium, i.e., less than about 9% by weight. In some instances, there may be advantages in maintaining the level of chromium at this reduced level. A specific range in some cases is about 5% by weight to about 8.5% by weight, and in some preferred embodiments, about 7% by weight to about 8.5% by weight. In these embodiments, the braze composition may include boron, e.g., at a level of about 0.05% to about 6% by weight. Other elements may also be present, as described previously, e.g., aluminum, tungsten, titanium, and some or all of the other secondary elements.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A nickel-based braze alloy composition, comprising:
about 5% to about 15% chromium by weight,
about 6% to about 26% hafnium by weight, and
balance nickel,
wherein the alloy composition is free of boron.

2. A nickel-based braze alloy composition, consisting essentially of:
about 5% to about 15% chromium by weight,
about 6% to about 26% hafnium by weight, and
about 50% to about 70% nickel by weight.

3. A nickel-based braze alloy composition, consisting essentially of:
about 5% to about 15% chromium by weight,
about 6% to about 26% hafnium by weight,
about 50% to about 70% nickel by weight, and
at least one of up to about 12% cobalt by weight; about 3% to about 7% tungsten by weight; up to about 2.5% titanium by weight; and about 1% to about 7% aluminum by weight.

4. The alloy of claim 1, comprising about 7% to about 9% chromium by weight.

5. The alloy of claim 1, comprising about 7% to about 8.5% chromium by weight.

6. The alloy of claim 1, comprising less than about 9% chromium by weight.

7. The alloy of claim 1, having a solidus temperature less than about 2175° F.

8. A method, comprising
placing a braze composition within a cavity of a component to be repaired;
heating the braze composition to a brazing temperature sufficient to melt the composition, but not the component; and
cooling the braze composition so that it re-solidifies within the cavity;
wherein the braze composition is selected from the group consisting of
A) a material which comprises
about 5% to about 15% chromium by weight,
about 6% to about 26% hafnium by weight, and
balance nickel,
and is substantially free of boron;
and
B) a material which consists essentially of:
about 5% to about 15% chromium by weight,
about 6% to about 26% hafnium by weight, and
about 50% to about 70% nickel by weight.

9. The method of claim 8, wherein the component is a component of a turbine engine.

10. A cobalt-based braze alloy composition, comprising:
about 5% to about 15% chromium by weight,
about 6% to about 26% hafnium by weight, and
balance cobalt,
wherein the alloy composition is free of boron.

11. The cobalt-based braze alloy composition of claim 10, further comprising at least one element selected from the group consisting of nickel, tungsten, titanium, and aluminum.

12. The cobalt-based braze alloy composition of claim 10, wherein the amount of cobalt present is about 50% by weight to about 70% by weight, based on the weight of the entire alloy composition.

13. The cobalt-based braze alloy composition of claim 10, further comprising:
about 3% by weight to about 7% by weight tungsten;
about 1% by weight to about 7% by weight aluminum;
up to about 12% nickel, by weight; and
up to about 2.5% titanium, by weight.

14. A braze alloy composition, comprising:
about 5% by weight to about 8.5% by weight chromium;
hafnium;
about 0.05% by weight to about 6% by weight boron; and
a balance which comprises nickel, cobalt, or a combination of nickel and cobalt.

15. The braze alloy composition of claim 14, further comprising at least one element selected from the group consisting of aluminum, tungsten, and titanium.
